(19) United States
(12) Patent Application Publication
(10) Pub. No.: US 2008/0293318 A1
(43) Pub. Date: Nov. 27, 2008

(54) FABRIC PRODUCTS

(76) Inventor: Iain Scorgie, London (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/123,825

(22) Filed: May 20, 2008

(30) Foreign Application Priority Data
May 22, 2007 (GB) 0709734.8

(51) Int. Cl. D03D 15/00; B32B 3/00

(52) U.S. Cl. 442/181; 428/172

(57) ABSTRACT

The invention relates to a woven material which has improved drying characteristics and can also have heating and/or cooling effect in certain environmental conditions. The material is formed from a mix of polyamide and polyester with a plurality of strands with each strand formed from a plurality of spools of fibre woven together. The strands are then divided and subsequently woven to form the material. The material can then be used on its own or in conjunction with other material layers to form items of clothing, towels, bed linen and the like.

The invention to which this application relates is a fabric product of a type which can be used to provide a drying effect such that the same can be provided, typically as a towel or other drying means, or an item of clothing which provides a drying effect as it is worn.

There are many robes, towels etc, available in the market place which are used for drying and which are claimed to have particular features which make them particularly useful such that they are claimed to be particularly soft, or particularly absorbent to water and therefore provide a quicker drying effect. However, it is commonly the case that the provision of a particular feature such as high absorbency, or particular softness, act to reduce other features of the fabric product such that a towel which is particular soft, may have a poorer drying effect or a towel which has a particularly high absorbency may be particularly hard.

The aim of the present invention is to provide a fabric which is particularly useful in providing a drying effect without adversely affecting the other useful features of the fabric.

In one aspect of the invention, there is provided a woven textile material, said textile material incorporating polyester and polyamide and the material is formed from a plurality of strands, wherein said strands are woven together in a plurality of spools to form the material.

In one embodiment each strand is formed from a plurality of spools of fibre woven together.

In one embodiment, each strand is of a dimension which is 50 or more times finer than the dimension of human hair in terms of cross sectional area.

In one embodiment, the strands are formed by dividing one or more fibers and subsequently woven to form the material which has the characteristics of being particularly soft, highly absorbent and quick drying.

Typically, the strands exhibit the characteristic of absorbing liquid in comparison to conventional fibre strands, which act to deflect liquid. By allowing the strands to absorb liquid, so the liquid is removed from the user's body or other surface and therefore provides a drying effect on said body or other surface.

In one embodiment, each strand includes more than 100 spools of fibre.

In one embodiment, the material in accordance with the invention is provided as a towel or in an alternative embodiment is provided as an item of clothing to be worn. Typically, in this embodiment, when the clothing is being worn, the clothing provides a drying effect on the wearer and acts to wick moisture from the wearer and clothing.

In one embodiment, the material is woven with a particular weave such as, for example, a chevron weave.

In one embodiment, the material in accordance with the invention is used in combination with one or more layers of other material to form an article. In one embodiment, if the article is an item of clothing to be worn, the material layer in accordance with the invention, will at least form the layer which is closest to the skin of the person wearing the clothing.

In one embodiment the composition of the material when woven includes polyester in the range 60-90% with the remainder being Polyamide. In one preferred embodiment the composition of the material when woven is 80% Polyester and 20% Polyamide.

In a further aspect of the invention there is provided a method of forming a woven textile material, said method including the steps of forming a plurality of fibres, dividing the fibres into strands and wherein said strands are then woven together in a plurality of spools to form the material.

In one embodiment each of the strands is formed from a plurality of spools and the strands may then in one embodiment be woven is spools or alternatively may be woven without spools.

Typically the method is performed using polyester and polyamide.

In a further aspect of the invention there is provided a method of forming a woven textile material, said method including the steps of forming a plurality of strands, wherein said strands are woven together and include a plurality of spools to form the material.

Typically the strands are formed by dividing a fibre into said strands.

Specific embodiments of the invention will now be described with reference to the accompanying drawings, wherein:—

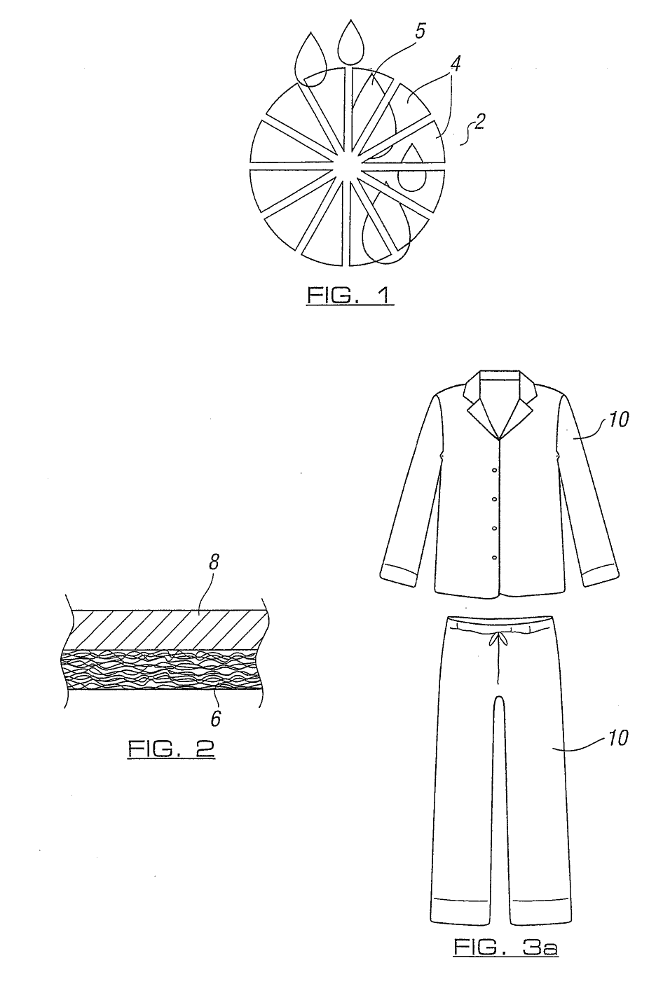

FIG. 1 illustrates a cross-sectional view of a strand used in the current invention;

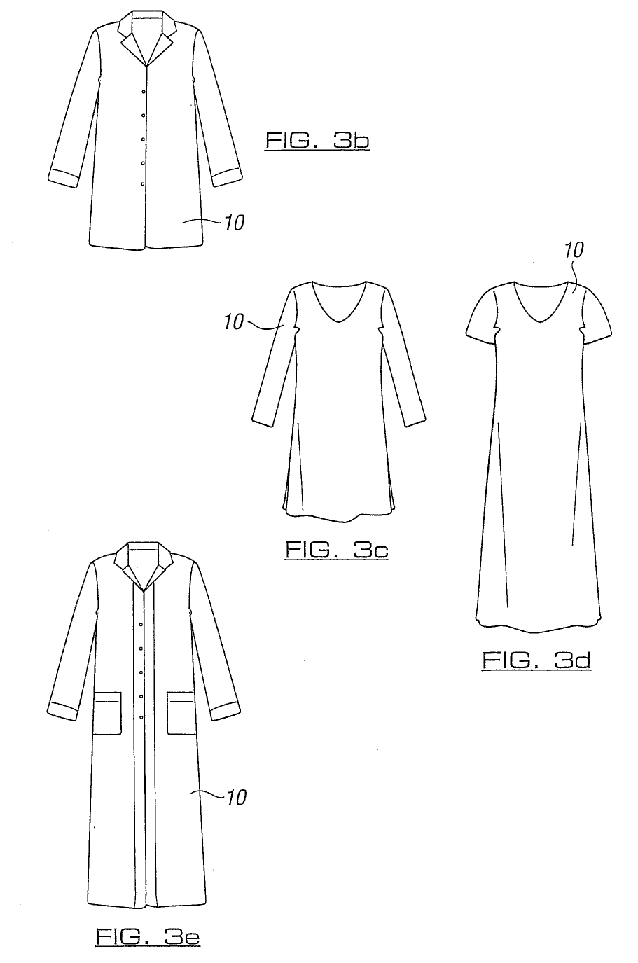

FIG. 2 illustrates a cross-sectional view of a plurality of the strands of FIG. 1 used to form the material in accordance with the invention; and

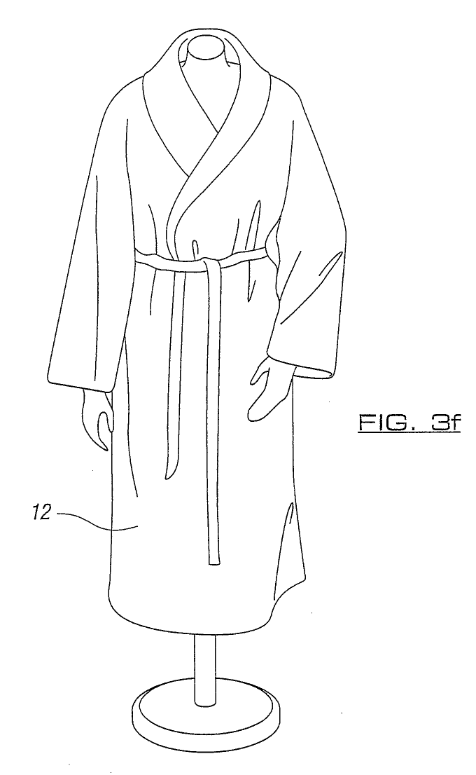

FIGS. 3a-f illustrate a range of clothing which can be manufactured using material in accordance with the invention.

Referring firstly to FIG. 1, there is shown, in a schematic cross-section, a fiber 2 of the type used in the invention to form the woven textile material. The fiber comprises a plurality of spools 4, which are divided out from the fiber and then woven together with a plurality of spools, to form the fibre. The provision of the spools allows the strands and hence the material to be absorbent to water 5 and thereby, rather than deflect liquid from the same, liquid is absorbed quickly and hence removes liquid from the other surface onto which the material has been applied and provides a drying effect on the other surface. Each strand is typically 100 times finer than human hair and typically 100's of spools of fibre will be used to form each strand. It will therefore be appreciated that each strand is particularly small in cross-sectional area and, each strand is then used, in combination with other strands, to form a material as shown in FIG. 2.

The weaving process to form the material from the strands includes a first step of dividing the strands and then weaving the same together with spools formed into the woven textile material of the type shown in FIG. 2.

Also, as illustrated in FIG. 2, the material in accordance with the invention can be used to provide a particular layer of the final article, rather than the whole article. For example, in this case, the layer of material in accordance with the invention, forms the layer 6 which is the inner layer of an article of clothing and the outer layer 8 can be formed of any other material to suit particular requirements and/or patterns. Thus, in use, the layer 6 is provided to be in contact with the surface which is to be dried, typically the skin of a person wearing the clothing so that while the clothing is being worn, the drying effect occurs automatically. Furthermore, as the material formed in accordance with the invention, also has a particularly soft feel, so the article, with the inner layer formed using the material of the invention, is particularly comfortable to wear.

FIGS. 3a to f, illustrate a range of different clothing types which can be worn and which have been formed using the material in accordance with the invention. For example, FIGS. 3a to d illustrate garments 10 of nightwear, which can be formed using the material of the invention, and which can therefore be worn both to provide a drying effect initially, and then as a nightwear garment thereafter.

FIG. 3f illustrates a toweling robe 12 which may be worn by a user after, for example, having a bath or shower and therefore be used to provide a drying effect.

Test results are shown below which illustrate the improved drying performance which can be obtained by the material in accordance with the invention in comparison to other materials which can conventionally be used for the same purposes.

Test results from SGS US Testing Co. Inc:

### Material Sample Descriptions:

“A”—robe formed of material of the invention with 80% polyester and 20% polyamide
“B”—100% cotton terry robe
“C”—80% polyester 20% nylon Towel
“D”—100% polyester robe
“E”—60% cotton 40% polyester waffle weave spa robe

Average water absorbency in seconds of the materials in original condition:

| Sample | Time |
|---|---|
| A | 1 sec. |
| B | 60 + Sec |
| C | 2 sec. |
| D | 60 + sec |
| E | 60 + sec |

(the term “60+ sec” means that within 60 seconds water did not absorb by the sample)

### Average Drying Rate in % of Sample in Original Condition

| | SAMPLES | | | | |
|---|---|---|---|---|---|
| After | A | B | C | D | E |
| 15 min | 10.1 | 7.1 | 6.6 | 11.2 | 8.7 |
| 30 min | 20.5 | 10.8 | 13.9 | 18.9 | 17.6 |
| 45 min | 29.4 | 14.5 | 20.9 | 26.9 | 26.2 |
| 60 min | 37.8 | 18.5 | 26.9 | 33.8 | 34.7 |

Therefore in both tests sample A of the material in accordance with the invention provided the best results when compared to conventional “drying” materials.

In addition, it should also be appreciated that it is possible to use material to form towels or the like and indeed any drying products can advantageously be formed using the material in accordance with this invention as it provides a product which is quick drying, highly absorbent of liquid and soft to the touch.

It should therefore be appreciated that the manufacturing method described herein produces a final material which is very soft, extremely absorbent and quick drying. This lends itself very well to all applications where water/moisture is present. For example towels, bath robes, nightwear, bath pillows, sports apparel, bed linen are all examples of articles which can be formed. The material can also be used for cleaning wet or dusty surfaces. The material also provides a warming effect in cold conditions and a cooling effect in hot conditions.

1. A woven textile material, said textile material incorporating polyester and polyamide and the material is formed from a plurality of strands, wherein said strands are woven together in a plurality of spools to form the material.

2. A material according to claim 1 wherein the strands are divided from a fibre and subsequently woven to form the material.

3. A material according to claim 1 wherein the strands absorb liquid when in contact therewith.

4. A material according to claim 3 wherein the material is provided as a towel and when used on a wet human body or other surface provides a drying effect on said body or other surface.

5. A material according to claim 1 wherein each strand includes more than 100 spools of fibre.

6. A material according to claim 1 wherein the material is used to form an item of clothing to be worn.

7. A material according to claim 6 wherein when the clothing is being worn, the clothing provides a drying effect on the wearer and acts to wick moisture from the wearer.

8. A material according to claim 1 wherein the material is woven with a chevron weave.

9. A material according to claim 1 wherein the material is used in combination with one or more layers of another material to form an article.

10. A material according to claim 9 wherein the article formed is an item of clothing and a layer of material as defined in claim 1 forms the layer which is closest to the skin of a person when wearing the clothing.

11. A material according to claim 1 wherein each strand is of a dimension which is 50 or more times finer than the dimension of human hair in terms of cross sectional area.

12. A material according to claim 1 wherein the composition of the material when woven includes polyester in the range 60-90% with remainder being Polyamide.

13. A material according to claim 12 wherein the composition of the material when woven is 80% Polyester and 20% Polyamide.

14. A method of forming a woven textile material, said method including the steps of forming a plurality of fibres, dividing the fibres into strands and wherein said strands are then woven together in a plurality of spools to form the material.

15. A method according to claim 14 wherein the strands include a plurality of spools.

16. A method according to claim 14 wherein the material comprises polyester and polyamide.

17. A method of forming a woven textile material, said method including the steps of forming a plurality of strands, wherein said strands are woven together and include a plurality of spools to form the material.

18. A method according to claim 17 wherein the strands are formed by dividing a fibre into said strands.
